(19) United States
(12) Patent Application Publication
(10) Pub. No.: US 2025/0374047 A1
(43) Pub. Date: Dec. 4, 2025

(54) LOCATION BASED AUTHENTICATION OF ACCOUNT CHANGES IN A WIRELESS NETWORK

(71) Applicant: T-Mobile Innovations LLC, Overland Park, KS (US)

(72) Inventor: Ahmad AL ACCAD, Renton, WA (US)

(21) Appl. No.: 18/678,201

(22) Filed: May 30, 2024

(51) Int. Cl. H04W 12/06; H04W 4/14; H04W 12/63

(52) U.S. Cl. CPC H04W 12/068; H04W 4/14; H04W 12/63

(57) ABSTRACT

Systems and methods are provided for authenticating account modifications in a wireless network. Methods include detecting a request to modify an account of an account holder at an authentication portal and further detecting an originating IP address associated with a location of the request. The methods further include transmitting an SMS message to the account holder identifying the request and a location of the request to modify the account and requesting a positive confirmation from the account holder to authorize the requested account modification. The methods further include transmitting the OTP via SMS to the account holder upon receiving the positive confirmation from the account holder.

### TECHNICAL BACKGROUND

Cellular subscriber accounts are increasingly becoming sought after targets of cyber-criminals. The accounts can be bought and sold, used to make large fraudulent purchases, and even used in other criminal activity. Like most online accounts, they tend to be secured with a username and password combination. Since these credentials may be vulnerable on their own, it is common for online account providers to make an extra layer of security available to their account holders in the form of one-time passwords (OTP). However, even OTPs are becoming susceptible to phishing attempts by cyber-criminals and other bad actors.

### OVERVIEW

Examples described herein include systems and methods for authenticating account changes in a wireless network. An exemplary method includes detecting a request to perform an account modification to an account of an account holder at an authentication portal. The method further includes identifying and recording a location associated with the request to perform the account modification. The method additionally includes transmitting a short messaging service (SMS) message to the account holder identifying the requested account modification and the recorded location and requesting a positive confirmation from the account holder to authorize the account modification from the recorded location. Further, the method includes transmitting a one-time password (OTP) via SMS to the account holder upon receiving the positive confirmation from the account holder.

Another exemplary embodiment includes a system having an authentication portal including at least one electronic processor configured to perform authentication operations. The authentication operations include receiving a request to perform an account modification to an account of an account holder and identifying and recording a location associated with the request. The operations additionally include triggering a short messaging service (SMS) message to the account holder. The SMS message identifies the account modification and the recorded location and requests a positive confirmation from the account holder to authorize the account modification requested from the recorded location. Further, the operations include triggering of a one-time password (OTP) via SMS to the account holder upon receiving the positive confirmation from the account holder.

Another exemplary embodiment includes a method of authenticating account modifications. The method includes receiving a request from a user having an IP address to perform a requested account modification on an account of an account holder at an authentication portal. The method additionally includes associating the IP address with a location and transmitting an SMS confirmation request to the account holder, wherein the SMS confirmation request indicates the requested account modification and the location and asks the account holder to provide a positive confirmation response to authorize the requested account modification or a negative confirmation response to prevent the requested account modification. The method further includes receiving the positive confirmation response via SMS from the account holder, and upon receiving the positive confirmation response, generating a one-time password (OTP) and transmitting the OTP to the account holder. The method additionally includes receiving a response OTP at the authentication portal from the user and upon validating that the response OTP matches the generated OTP, performing the requested account modification and notifying the account holder via SMS that the requested account modification has been completed.

### BRIEF DESCRIPTION OF THE DRAWINGS

These and other more detailed and specific features of various embodiments are more fully disclosed in the following description with reference to to the accompanying drawings.

FIG. 1 illustrates an exemplary environment for authenticating account modifications.

FIG. 2 illustrates an exemplary system for authenticating account modifications in a wireless network in accordance with various aspects of the present disclosure.

FIG. 3 illustrates a further exemplary system in accordance with various aspects of the present disclosure.

FIG. 4 illustrates an exemplary process flow for authenticating account modifications in a wireless network.

FIG. 5 illustrates a further exemplary process flow for authenticating account modifications in a wireless network.

FIG. 6 illustrates an additional exemplary process flow for authenticating account modifications in a wireless network.

FIG. 7 illustrates an additional more detailed exemplary process flow for authenticating account modifications in a wireless network.

FIG. 8 illustrates an additional more detailed exemplary process flow for authenticating account modifications in a wireless network.

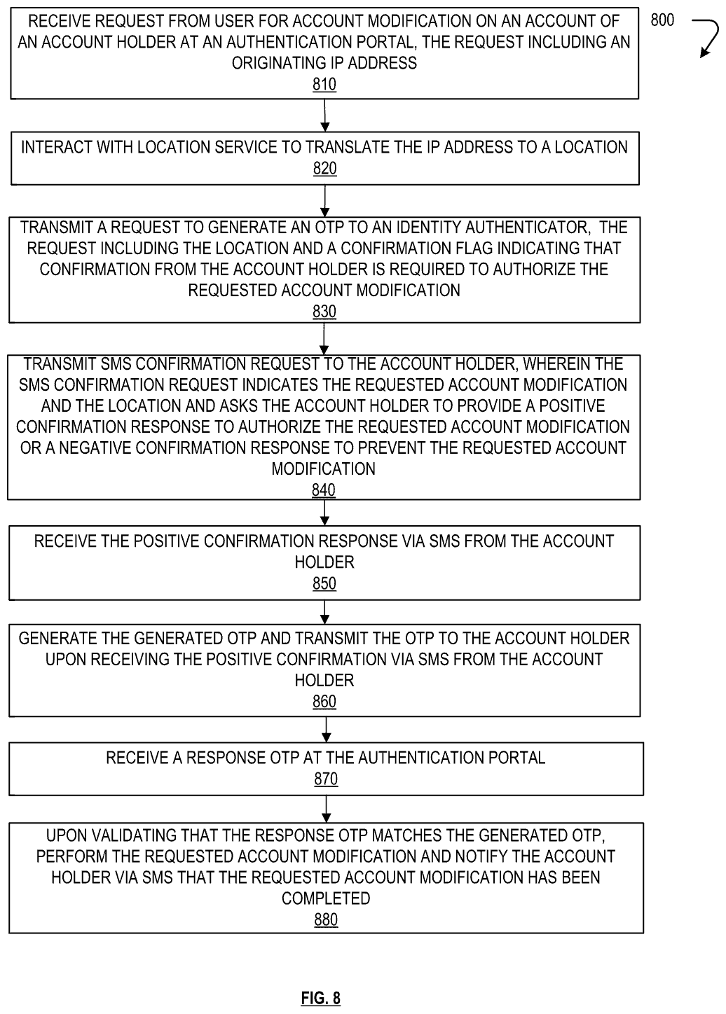

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a cellular or wireless network may be provided by a wireless provider. Access to a cellular account may be made available to the account holder via the wireless provider website. The account holder is required to login to a corresponding account to gain access to account details, usually by way of a username and password. Once authenticated, the account holder can perform many different functions such as adding or removing lines of service, ordering new equipment, or changing service levels, for example. There are also many functions that are common to other types of online accounts as well, such as changing the account password or the account holder contact information including mailing address or email address. Online accounts, whether for cellular subscribers or otherwise, also have mechanisms to assist account holders who forget their username and/or password. Often, the online platform presents a link at a login page for resetting a forgotten password. The user will then be presented with options for identify verification. Identity verification can be accomplished by having the provider send an email to the email address on record for the account, having the user answer security questions, using an external authenticator application, or via an OTP sent via SMS to the account holder's mobile phone. Each of those methods may have different levels of convenience and vulnerability.

Recently, OTPs sent via SMS have increasingly been coming under attack by bad actors using phishing methods on unsuspecting victims. Phishing is a social engineering attack where the victim is convinced to divulge confidential information under false pretenses. A common scheme is for a bad actor to send an SMS message to the victim claiming that the victim has won something, such as money and stating that all the victim needs to do is confirm the OTP that the victim will shortly receive. The bad actor then triggers the reset password mechanism causing the cellular provider to send an OTP to the victim through the account holder phone. If the account holder falls for the scheme and sends the OTP to the bad actor by replying to the phishing SMS message with the OTP, the bad actor then uses the OTP to reset the password on the account and now has full access to the account. Despite the usual warning accompanying the OTP stating never to share the OTP with anyone, it is often ignored by those falling for phishing schemes. These types of phishing attacks may be thwarted by adding an extra confirmation steps as disclosed herein.

The extra steps include requesting a positive confirmation from the account holder before sending the OTP and before the account is modified. Further, the extra steps include determining a location at which the modification request originated, e.g., from the Internet Protocol (IP) address of the request and sending the location with the request for positive confirmation from the account holder.

The process for resetting a password begins when the user is presented with a login page by a service provider website including an authentication portal. The login page provides a link allowing the user to initiate the process of resetting the password. Upon activating the reset password link, the user is presented with different methods of identity verification based on the account setup. For example, if the account profile includes security questions and answers, those security questions may be utilized to verify the user identity. Other ways of verifying the user identity include sending an OTP to the account holder's email address or sending an OTP via SMS to the account holder's phone number. The user, who may be the bad actor, may select the SMS OTP option, which will start the process disclosed herein for an SMS confirmation message to be sent to the account holder's phone number. This SMS confirmation message does not include the OTP. Instead, it includes a record of the account modification request along with a location from which the account modification request originated. The SMS confirmation message further includes a request for positive confirmation. The positive confirmation must occur in order for the OTP to be forwarded to the account holder.

In some embodiments, this confirmation message may be triggered by sending a command from the authentication portal receiving the account modification request to an identity authenticator to generate the OTP and including a parameter within the command indicating that confirmation is required before creating the OTP. The command to generate the OTP may be the “generateTempPin” command and the parameter may be Boolean and contain “True” when confirmation is required and “False” when confirmation is not required, for example. Further, utilizing the location based authentication system, the authentication portal will detect and record the internet protocol (IP) address of the user attempting to log in. The IP address parameter may be incorporated in the “generateTempPin” command as an additional parameter along with Boolean parameter requiring confirmation and the mobile station international subscriber directory number (MSISDN). As an alternative to the IP address, the generateTempPin command may accept the actual location associated with the IP address of the requesting device. The location can be obtained from an internal or external location service based on the IP address. The location service may return a location corresponding to the IP address. For example, an IP address of 208.42.23.111 translates to Seattle, Washington.

In embodiments provided herein, the identity authenticator records and generates the confirmation message and incorporates the IP address or location variable in the SMS template. The identity authenticator sends the generated confirmation message to a service delivery gateway including the text of the SMS confirmation message. The text of this message would include the operation being attempted and instructions requesting a positive or negative confirmation of the action. For example, the text could include, “Someone is trying to reset your account password from Seattle, Washington. Please confirm it is you by replying YES to this message. If it was not you, please reply NO to this message”. The service delivery gateway would then forward the message to an SMS center, which then forwards the message to the mobile device of the account holder. Upon receipt of the message, the account holder may respond with a positive confirmation (YES), a negative confirmation (NO) or not respond at all.

A positive confirmation reply will be sent through the SMS center and the delivery gateway to the identity authenticator. The identity authenticator considers the account holder to be verified, and the identity authenticator generates the OTP and sends it back through the delivery gateway and SMS center to the account holder's device. The authentication portal presents to the user a dialog box for inputting the OTP. The user inputs a response OTP and the authentication portal forwards the OTP to the identity authenticator for verification. The verification occurs by comparing the response OTP with the generated OTP. If the OTP is verified, the account change is authorized, and the user is prompted to input a new password. The new password is forwarded to the identity authenticator. The identity authenticator may then trigger a confirmation SMS message confirming that the account change has been completed. The confirmation SMS message is forwarded to the account holder device, for example, through the delivery gateway and the SMS center.

When the account holder inputs a negative confirmation reply, the reply is sent to the identity authenticator through the SMS center and the delivery gateway. If the identity authenticator receives the negative confirmation reply or receives no reply at all after a predetermined threshold period of time, the user is considered unverified, and the account modification will be denied. Upon denial of the account modification, the identity authenticator may generate a confirmation SMS message stating that the account modification has been prevented. The confirmation SMS message will be forwarded to the account holder device.

The delivery gateway and SMS center provide one method of delivering SMS messages. The delivery may be performed by other apparatus. For example, the SMS center and delivery gateway may be combined into a single service or SMS delivery could be performed by another entity.

The same confirmation process may be used for other account modifications as well. For example, a request to change contact information may require the use of an OTP for confirmation and therefore may use the confirmation process disclosed herein to further secure this and other account modifications as well.

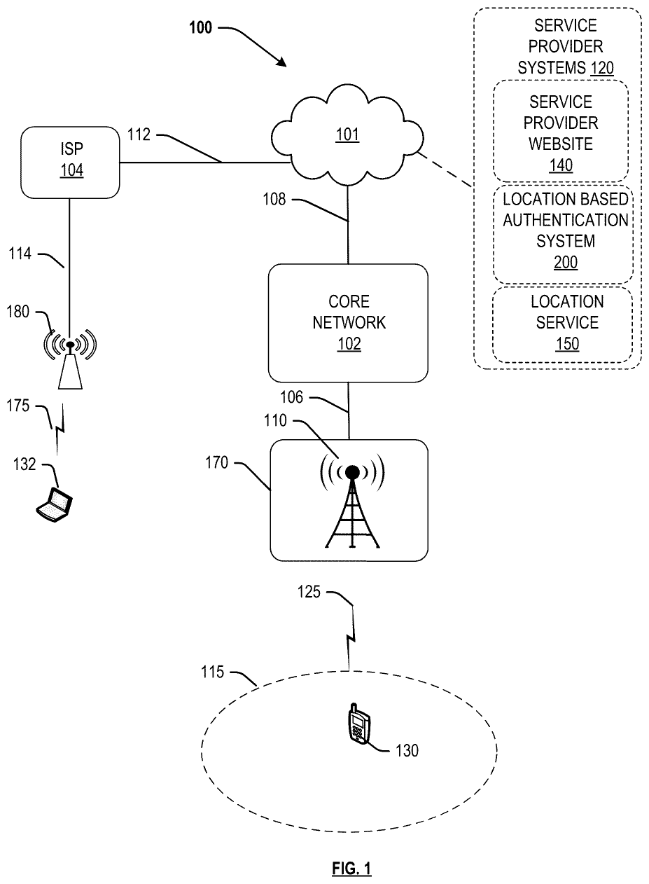

FIG. 1 depicts an exemplary environment 100 for utilizing a location based authentication system 200. In the displayed environment 100, the location based authentication system 200 operates to perform authentication based on an originating location of an account modification attempt. For example, wireless devices 130 and 132 may attempt to access an account through communication with a website accessible through network 101. In examples provided herein, wireless device 132 may be operated by a bad actor and wireless device 130 may be an account holder device.

Environment 100 comprises a communication network 101, core network 102, and a radio access network (RAN) 170 including at least an access node 110. Wireless device 130 is within a coverage area 115 and may communicate with the access node 110 over a wireless communication link 125. Further, wireless devices 132 may access the communication network through a router or wireless access point 180 using a communication link 175 and Internet service provider (ISP) 104. Further, the location based authentication system 200 operates to ensure requests made by the wireless devices 130 and 132 are properly processed, Additionally, components not shown may include, for example, gateway node(s) controller nodes, and additional access nodes.

Access node 110 can be any network node configured to provide communication between end-user wireless device 130 and communication network 101, including standard access nodes and/or short range, low power, small access nodes. For instance, access node 110 may include any standard access node, such as a macrocell access node, base transceiver station, a radio base station, an eNodeB device, an enhanced eNodeB device, a next generation NodeB device (gNBs) in 5G networks, or the like. Moreover, it is noted that while access node 110 and wireless devices 130 and 132 are illustrated in FIG. 1, any number of access nodes and wireless devices can be implemented within environment 100.

The exemplary operating environment 100 may further include service provider systems 120, which are accessible over the communication network 101 and are connected to the communication network 101 in any known manner. The service provider systems 120 may include a service provider website 140, a location service 150, and the location based authentication system 200. Additional service provider systems may also be included.

In embodiments set forth herein, an account modification attempt by a wireless device 132 occurs when the wireless device 132 access the service provider website 140 over the communication network 101. When the access involves an account modification, the location based authentication system 200 is triggered. The location based authentication system 200 may utilize the IP address of the user accessing the website and determine a location associated with the IP address through communication with the location service 150. The location based authentication service may further operate in conjunction with components of the core network 102 and the RAN 170 to trigger an SMS message to wireless device 130, which may be an account holder wireless device.

The location based authentication system 200 receives requests from the wireless devices 132 to access and modify accounts of account holders. For example, the location based authentication system 200 may operate on requests received at the communication network 101, for example, requests received at the service provider website 140. Exemplary operations include processing requests to determine IP address and the requested account modifications and generating confirmation messages requiring a positive response and indicating an originating location of the received requests. The confirmation messages may require a positive response from the account holder in order for account modifications to be made.

Access node 110 can comprise a processor and associated circuitry to execute or direct the execution of computer-readable instructions to perform operations such as those further described herein. Access node 110 is capable of communicating with the core network 102 as well as various additional nodes including gateway nodes, controller nodes, and other access nodes. Further, the access node 110 may communicate with the location based authentication system 200 or alternatively may wholly or partially incorporate the location based authentication system 200.

Wireless devices 130 and 132 may be any device, system, combination of devices, or other such communication platform capable of communicating wirelessly with access node 110 using one or more frequency bands deployed therefrom and with communication network 101. Wireless devices 130 and 132 may be or include, for example, a mobile phone, a wireless phone, a wireless modem, a personal digital assistant (PDA), a voice over internet protocol (VoIP) phone, a voice over packet (VOP) phone, a soft phone, a tablet or laptop, a home internet (HINT) device, a fixed wireless access (FWA) device as well as other types of devices or systems that can exchange audio or data via access node 110.

The core network 102 includes core network functions and elements. The core network may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions handle connection and mobility management tasks. The control plane functions further are responsible for creating, updating, and removing sessions and managing session context and for providing services to other core functions. The control plane functions further assist with the selection of network slice instances that will serve a particular device.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices. Communication network 101 can also comprise additional base stations, controller nodes, telephony switches, internet routers, network gateways, computer systems, communication links, or some other type of communication equipment, and combinations thereof.

Communication links 106, 108, 112, and 114 can use various communication media, such as air, space, metal, optical fiber, or some other signal propagation path, including combinations thereof. Communication links 106, 108, 112, and 114 can be wired or wireless and use various communication protocols such as Internet, Internet protocol (IP), local-area network (LAN), optical networking, hybrid fiber coax (HFC), telephony, T1, or some other communication format. Communication links 106, 108, 112, and 114 can be a direct link or might include various equipment, intermediate components, systems, and networks. Communication links 106, 108, 112, and 114 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

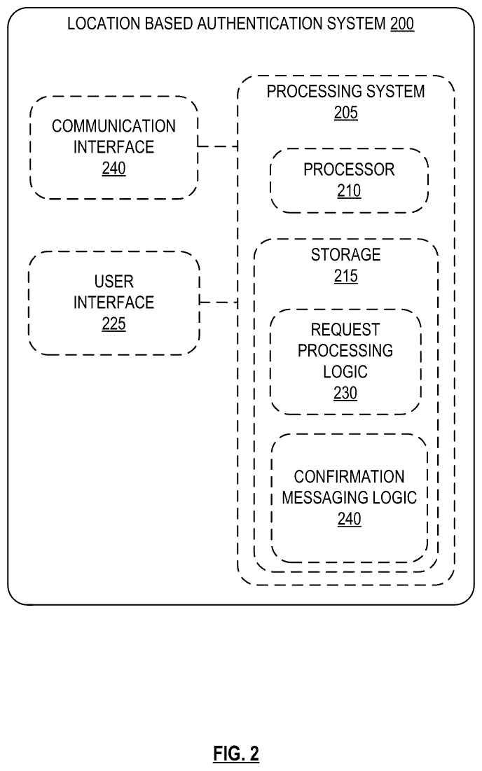

FIG. 2 illustrates a location based authentication system 200 in accordance with embodiments described herein. The components described herein are merely exemplary as many different configurations for the location based authentication system 200 may be implemented. The location based authentication system 200 may be configured to perform the methods and operations disclosed herein to protect account holders against fraudulent account access and modifications. In the disclosed embodiments, the location based authentication system 200 may be integrated with a web site hosted on the communication network 101, or may further have portions integrated with access node 110 or core network 102 or may be an entirely separate component capable of communicating with the aforementioned components as well as the wireless devices 130 and 132. Further, the components of the location based authentication system 200 may be distributed.

The location based authentication system 200 may utilize a processing system 205. Processing system 205 may include a processor 210 and a storage device 215. Storage device 215 may include a RAM, ROM, disk drive, a flash drive, a memory, or other storage device configured to store data and/or computer readable instructions or codes (e.g., software). The computer executable instructions or codes may be accessed and executed by processor 210 to perform various methods disclosed herein.

Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein. For example, request processing logic 230 may operate to receive and process account access and modification requests submitted to a web site hosted by the communication network 101. In processing the requests, the request processing logic 230 may be executed by the processor 210 to identify an originating IP address of the request. Based on the originating IP address, the request processing logic 230 may ascertain an originating location of the request. The location may be or include a city, state, and country. The location may more specifically identify a location within a city. The request processing logic 230 may consult with an internal or external or external location service 150 in order to associate the IP address with a location.

Additionally, confirmation messaging logic 240 may be executed by the processor 210 to generate a confirmation message to an account holder. The confirmation message to the account holder includes the location as determined by the request processing logic 230. The confirmation messaging logic 240 may further formulate a confirmation message requiring a positive response from an account holder prior to triggering transmission of an OTP.

Processor 210 may be a microprocessor and may include hardware circuitry and/or embedded codes configured to retrieve and execute software stored in storage device 215. The location based authentication system 200 further includes a communication interface 220 and a user interface 225. Communication interface 220 may be configured to enable the processing system 205 to communicate with other components, nodes, or devices in the wireless network

Communication interface 220 may include hardware components, such as network communication ports, devices, routers, wires, antenna, transceivers, etc. User interface 225 may be configured to allow a user to provide input to the location based authentication system 200. User interface 225 may include hardware components, such as touch screens, buttons, displays, speakers, etc. The location based authentication system 200 may further include other components such as a power management unit, a control interface unit, etc.

As set forth above, the location based authentication system 200 may be a separate processing node operating in conjunction with a website accessible through communication network 101. Further, although shown as a single integrated system, the functions performed by the location based authentication system may be separated and disposed in separate locations.

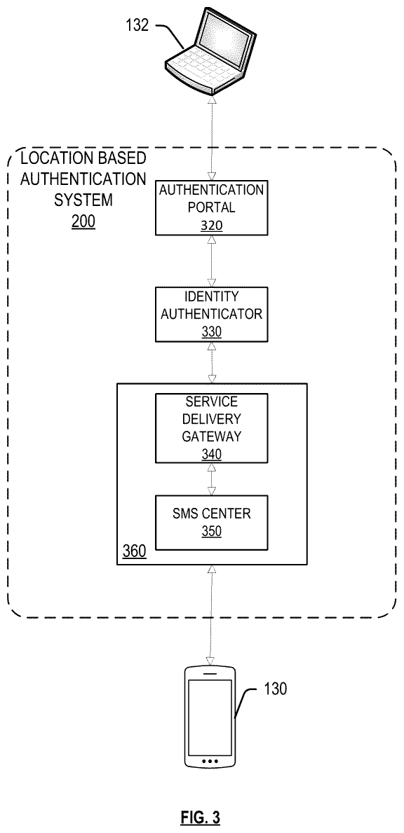

FIG. 3 depicts an exemplary environment 300 for authenticating account changes in a wireless network. Environment 300 includes a wireless device or user computer 132. The wireless device or user computer 132 could be any electronic device with the capability of accessing the login web page of the account provider. Examples include, a laptop or desktop computer, a mobile phone or a tablet.

Environment 300 further includes location based authentication system 200 having an authentication portal 320, an identity authenticator 330, and an SMS delivery service 360. The SMS delivery service 360 includes a service delivery gateway 340 and an SMS center 350. The service delivery gateway 340 provides many different delivery routing services outside the scope of this disclosure. The SMS delivery service 360 is a logical representation of the service delivery gateway 340 and the SMS center 350 for the purposes of clarity and to illustrate how those two elements work together to transmit SMS messages back and forth between a service provider and the account holder. During the operations disclosed herein, any SMS messages received by the service delivery gateway 340 are forwarded through the SMS center 350 and then relayed to the account holder mobile device 130. Likewise, any SMS messages received by the SMS center 350 are forwarded through the service delivery gateway 340 to other elements of the provider network, such as those illustrated in FIG. 1. The SMS delivery service 360 may include separate devices providing the services of the service delivery gateway 340 and the SMS center 350 or it may be a single device providing both services.

Also illustrated in environment 300 is the mobile device 130 of the account holder. The mobile device 130 is illustrated as a smart phone but could be any similar device capable of receiving and sending SMS messages. Some examples of other devices include legacy phones, tablets, PDAs, and smart watches.

The authentication portal 320 presents the login interface on the service provider website 140 that is accessed by a user in a web browser. The login interface includes elements for logging into the account, resetting the account password, changing the account password, changing the contact information for the account holder, and other functions typical of an authentication web interface. At the authentication portal 320, a request is received from the wireless device or user computer 132 to access or modify an account of an account holder. The authentication portal 320 transmits to the identity authenticator 330 a request to generate an OTP. The request may contain a confirmation flag indicating that confirmation is required by the account holder before generating the OTP. The request further includes a location parameter or an IP address parameter. Either the authentication portal 320 or the identity authenticator 330 may provide the IP address to a location service, such as the location service 150 in order to obtain a location from the IP address. The identity authenticator 330 will, upon receiving the request to generate the generated OTP, transmit a confirmation request message to an SMS delivery service 360, wherein the confirmation request message notifies the account holder of the request to modify the account as well as the location of origin of the request and instructs the account holder to reply with a positive confirmation response to approve the account modification. The SMS delivery service 360 then forwards the confirmation request message to the account holder mobile device 130. The account holder may reply with a positive confirmation response, such as a YES, a negative confirmation response, such as a NO, or may not reply at all.

Upon transmission of a positive confirmation response, the response is received at the SMS delivery service 360 and forwarded to the identity authenticator 330. The identity authenticator 330 generates the OTP and forwards it through the SMS delivery service 360 to the account holder mobile device 130. If the account holder has requested the account modification, the account holder enters a response OTP into the interface provided by the authentication portal 320. Once the authentication portal 320 receives the response OTP, it forwards the response OTP to the identity authenticator 330. The identity authenticator 330 validates that the response OTP matches the generated OTP and sends a notification to the authentication portal 320 that the response OTP has been validated. The authentication portal 320 then proceeds with the account modification as requested by the user. Once the account modification is complete, the authentication portal 320 may trigger an operation completed SMS notification to indicate that the account modification has been completed. The identity authenticator 330 will then generate the operation complete SMS notification and forward it through the SMS delivery service 360 to the account holder mobile device 130.

The account modifications being requested could be any account modifications that require two-factor authentication using an OTP. Examples include resetting a password, changing a password, and changing the contact information for the account holder, including mailing address or email address. The request to generate the OTP may be the “generateTempPin” command and the parameter may be Boolean, containing “True” when confirmation is required and “False” when confirmation is not required, for example. Further, the authentication portal 320 detects and records an originating IP address of the user attempting the account modification. The authentication portal 320 may send the IP address as a parameter within the generateTempPin command to the identity authenticator 330 along with the mandatory MSISDN. Alternatively, the authentication portal 320 may interact with a location service 150 to identify a location that corresponds to the IP address. In this case, the authentication portal 320 sends the corresponding location in the command rather than the IP address.

The application program interface (API) for the generate TempPin command can accept either the IP address or the location associated with the IP address. If the IP address is included by the authentication portal 320, then the identity authenticator 330 establishes a connection with the location service 150 to associate the IP address with a location. The identity authenticator 330 considers the location as a variable and transmit its value within the SMS template. However, the identity authenticator 330 may log both the IP address and the associated location for security purposes.

The identity operations may further include transmitting an SMS notification via the SMS delivery service 360 to the account holder mobile device 130 indicating that the account modification has been prevented upon receiving a negative confirmation from the account holder. The identity operations may further include transmitting an SMS notification to the account holder mobile device 130 via the SMS delivery service 360 indicating that the account modification has been prevented upon the passing of a predetermined timeout period from the notification to the account holder indicating the request to modify the account without receiving the positive confirmation or a negative confirmation. The predetermined timeout period may be set by the provider and could range from a few minutes to a full day.

Other network elements may be present in environment 300 to facilitate communication but are omitted for clarity, such as access nodes, base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements.

Accordingly, the embodiment as illustrated in FIG. 3 includes authentication operations, identity operations, and delivery operations performed respectively through the authentication portal 320, identity authenticator 330, and SMS delivery service 360. Authentication operations may include receiving a request from a user to modify an account of an account holder and processing the request. In order to process the request, authentication operations may further include transmitting, to an identity authenticator, a request to generate an OTP, wherein the request to generate the OTP includes a confirmation flag indicating that confirmation by the account holder is required before generating the OTP and further includes a location or IP address from which the request to modify originated. Authentication operations may further include receiving a response OTP from the user and upon receiving the response OTP, transmitting the response OTP to the identity authenticator. Authentication operations may further include performing the requested account modification once the received OTP is validated.

Identity operations may include upon receiving the request to generate the OTP, transmitting a confirmation request message to an SMS delivery service, wherein the confirmation request message notifies the account holder of the request to modify the account and the location of origin of the request and instructs the account holder to reply with a positive confirmation response to approve the requested account modification. In some instances, the identity operations include interacting with the location service 150 to determine a location corresponding to a received IP address. The identity operations may further include generating the OTP upon receiving the positive confirmation response. The identity operations may further include transmitting the OTP to the SMS delivery service 360. The identity operations may further include receiving the response OTP from the authentication portal and validating that the response OTP matches the OTP. The identity operations may include transmitting notification to the authentication portal that the response OTP has been validated.

Delivery operations may include transmitting the confirmation request message to the account holder. Delivery operations may include receiving the positive confirmation response from the account holder and transmitting the positive confirmation response to the identity authenticator. Delivery operations may include transmitting the OTP to the account holder upon receiving the OTP from the identity authenticator.

Identity operations may optionally include upon receiving a negative confirmation response from the account holder, transmitting an SMS notification to the account holder mobile device 130 via the SMS delivery service indicating that the requested account modification has been prevented. Identity operations may optionally include upon the passing of a predetermined timeout period from the confirmation request message being transmitted to the account holder without receiving the positive confirmation response or the negative confirmation response, transmitting an SMS notification to the account holder mobile device 130 via the SMS delivery service indicating that the requested account modification has been prevented. The predetermined timeout period may be set by the provider and could range from a few minutes to a full day.

Authentication operations may optionally include triggering an operation complete SMS notification to the account holder mobile device 130 indicating that the requested account modification has been completed. Identity operations may optionally include transmitting the operation complete SMS notification to the SMS delivery service 360. Delivery operations may optionally include transmitting the operation complete SMS notification to the account holder mobile device 130.

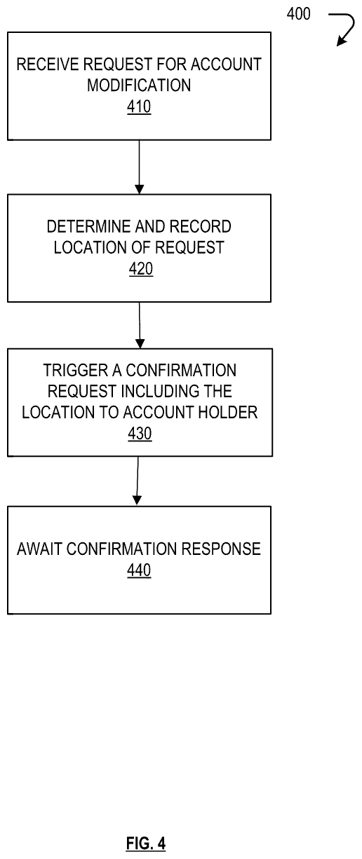

FIG. 4 illustrates an exemplary method 400 for authenticating account changes in a wireless network. Method 400 may be performed by any suitable combination of processors, such as the processor 210 or the processor 210 in conjunction with other processors. Although FIG. 4 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 400 begins in step 410 where a request to modify an account of an account holder is detected. The request may be detected, for example, at an authentication portal as discussed above. The request may include accompanying information, such as, for example, an originating IP address as well as a requested change.

Method 400 continues in step 420, in which the processor determines and records the originating location of the modification request. As set forth above, the request itself may include an IP address. The processor 210 then may correlate the IP address with a location based on an existing reference structure, such as a table or database stored with a location service. The location may be or include a city, state, or country or more precise address information.

Method 400 continues in step 430 where the processor triggers the sending of a confirmation request including the recorded location to an account holder mobile device. The confirmation request may be transmitted using an SMS message. The SMS message identifies the request to modify the account and the originating location of the request and requests a positive confirmation from the account holder to authorize the account modification.

Method 400 continues in step 440, in which the processor 210 awaits a confirmation response. As will be further explained herein, the confirmation response may be or include a positive response, a negative response, or a time lapse exceeding a predetermined threshold, which is equated with a negative response.

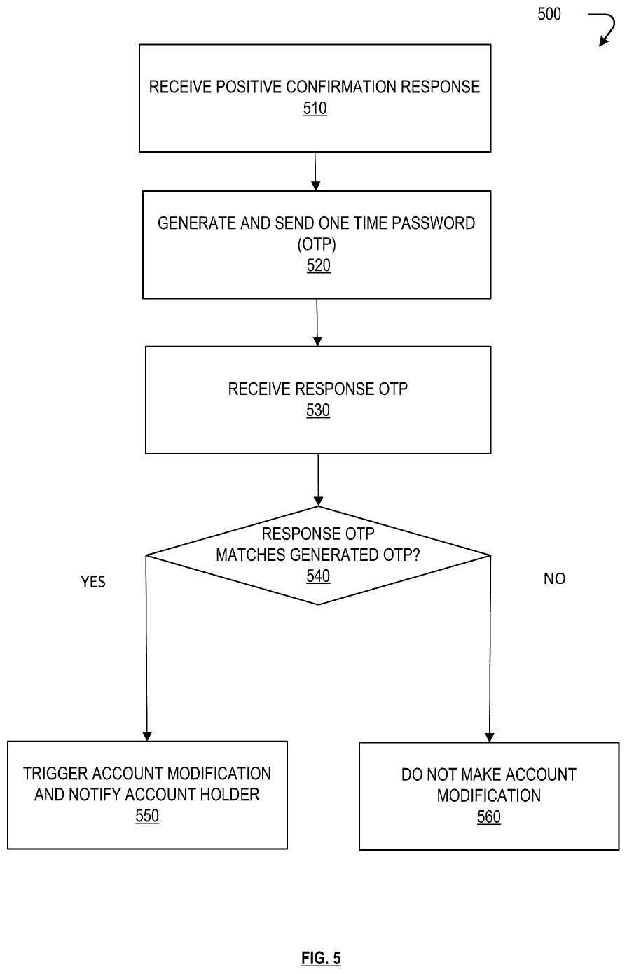

FIG. 5 illustrates an exemplary method 500 for location based authentication in a wireless network. More specifically, FIG. 5 illustrates a method that occurs upon receipt of a positive confirmation response after step 440 of FIG. 4. Method 500 may be performed by any suitable combination of processors, such as the processor 210 or the processor 210 in conjunction with other processors. Although FIG. 5 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 500 begins in step 510 with receipt of a positive confirmation response at the processor 210. For example, in response to the SMS text providing the location of origin of the modification request and the particular requested modification, the processor 210 receives a confirmation response. For example, the processor 210 may receive a “YES” response from the account holder mobile device.

In step 520, in response to the positive confirmation response, the processor 210 triggers the sending of an OTP to the account holder mobile device. The OTP may be or include a series of numbers, letters, or symbols, or a combination of letters, numbers, and symbols.

In step 530, in response to the transmission of the OTP, the processor 210 receives a response OTP. In other words, in order to authorize the account modifications, the account holder is asked to re-enter the received OTP on the website of the service provider. Accordingly, the account holder sends the response OTP.

In step 540, the processor 210 determines whether the response OTP matches the originally generated OTP. If the response OTP does not match, the processor does not make the requested modification in step 560. However, if the response OTP does match the generated OTP, the processor triggers the account modification and notifies the account holder in step 550.

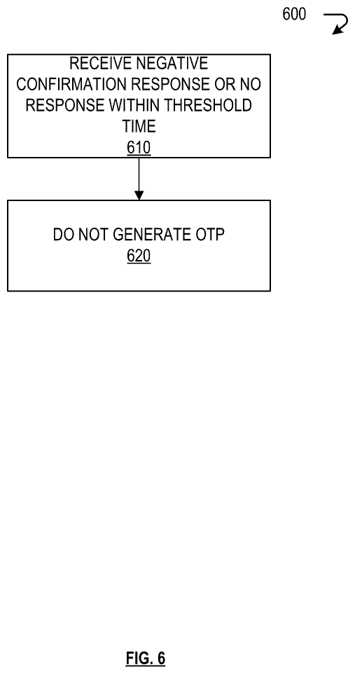

FIG. 6 illustrates an exemplary method 600 for location based authentication in a wireless network. More specifically, FIG. 6 illustrates a method that occurs after step 440 of FIG. 4. Method 600 may be performed by any suitable combination of processors, such as the processor 210 or the processor 210 in conjunction with other processors.

Method 600 begins in step 610 with receipt of a negative confirmation response at the processor 210. For example, in response to the SMS text providing the location of origin of the modification request and the particular requested modification, the processor 210 receives a negative confirmation response. For example, the processor 210 may receive a “NO” response from the account holder mobile device. As an alternative, the service provider may set a predetermined time threshold, for example, between one minute and one day, for receiving the response. If no response is received upon expiration of the time threshold, the lack of response will be considered a negative confirmation response. Accordingly, in step 620, upon deeming the response to be negative, the processor 210 refrains from generating an OTP and further may trigger a notification to the account holder mobile device indicating that no account modification has been made.

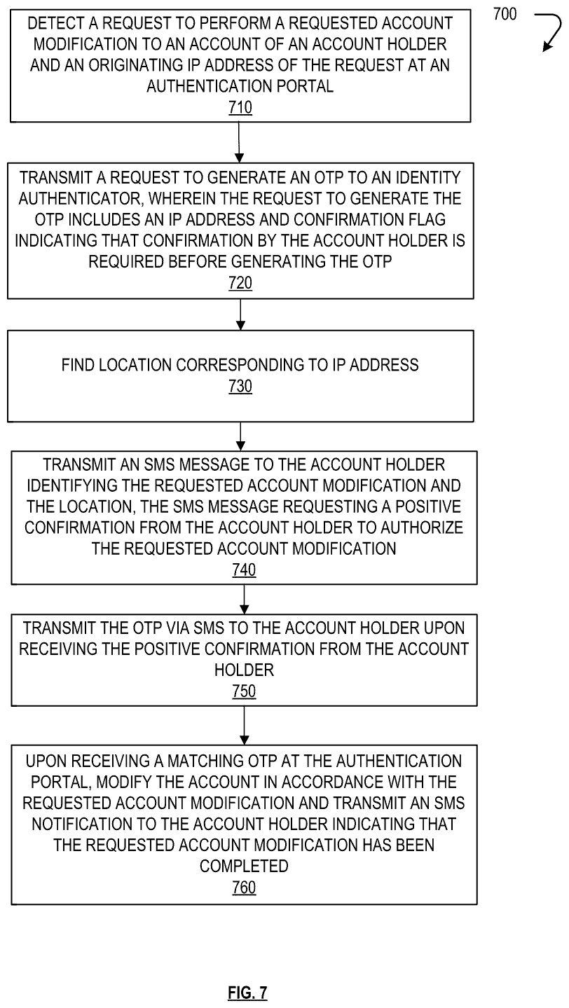

FIG. 7 illustrates a more detailed exemplary method 700 for authenticating account changes in a wireless network. Method 700 may be performed by any suitable combination of processors, such as the processors of the authentication portal 320, identity authenticator 330, and SMS delivery service 360. Alternatively the method may be performed by processor 210 or in combination with processors from other systems. Although FIG. 7 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 700 begins in step 710 where a request to modify an account of an account holder is detected at an authentication portal. The request includes metadata such as an indicator of location, which may, for example, be an IP address. Method 700 continues in step 720 where a request to generate an OTP is transmitted to an identity authenticator. The request includes the received IP address and a confirmation flag indicating that confirmation by the account holder is required before generating the OTP. In step 730, the identity authenticator interacts with a location service to associate the IP address with a location. The identity authenticator provides the IP address and the location service 150 responds with the corresponding location. Accordingly, the identity authenticator transmits the location as a variable within the SMS template and further logs both the IP address and location for security purposes.

Method 700 continues in step 740 where an SMS message is transmitted to the account holder mobile device. The SMS message identifies the request to modify the account as well as the location of the request and requires a positive confirmation from the account holder to authorize the account modification. Method 700 continues in step 750 where the OTP is transmitted via SMS to the account holder mobile device upon receiving the positive confirmation from the account holder. Method 700 continues in step 760 where, upon receiving the response OTP that matches the generated OTP at the authentication portal, the account is modified in accordance with the request to modify the account and an SMS notification indicating that the account modification has been completed is transmitted to the account holder mobile device.

Method 800 begins in step 810 where a request to modify an account of an account holder is detected at an authentication portal. The request includes metadata such as an indicator of location, which may, for example, be an IP address. In step 820, the authentication portal interacts with the location service in order to determine a location associated with the IP address.

Method 800 continues in step 830 where a request to generate an OTP is transmitted to an identity authenticator. The request may be a generateTempPin command, including the location of the request determined in step 820 and a confirmation flag indicating that confirmation by the account holder is required before generating the OTP.

Method 800 continues in step 840 where an SMS confirmation request is transmitted to the account holder. The SMS confirmation request indicates that the account modification has been requested, provides the originating location, and asks the account holder to provide a positive confirmation response to authorize the account modification or a negative confirmation response to prevent the account modification. Method 800 continues in step 850 where the positive confirmation response is received via SMS from the account holder. Method 800 continues in step 860 where the OTP is generated and transmitted to the account holder upon receiving the positive confirmation response. Method 800 continues in step 870 where a response OTP is received at the authentication portal. Method 800 continues in step 880 where, upon validating that the response OTP matches the generated OTP, the requested account modification is performed, and the account holder is notified via SMS that the account modification has been completed.

Methods 700 and 800 may include an optional step of transmitting an SMS notification to the account holder indicating that the account modification has been prevented upon receiving a negative confirmation response from the account holder. Methods 700 and 800 may include an optional step of transmitting an SMS notification to the account holder indicating that the account modification has been prevented upon the passing of a predetermined timeout period from the notification to the account holder indicating the request to modify the account without receiving the positive confirmation response or a negative confirmation response. The predetermined timeout period may be set by the provider and could be as low as a few minutes or even up to a full day. The account modifications being requested could be any sort of account modifications that require two-factor authentication using an OTP. Examples include resetting a password, changing a password, and changing the contact information for the account holder, including mailing address or email address

Accordingly, in embodiments set forth herein, account modifications such as password resets become more secure through via an SMS OTP flow by sending the location of the device initiating the reset password flow to the device receiving the OTP. Incorporating location data into the password reset or forgotten password procedure provides further security and empowers the account holder to make informed decisions, particularly when dealing with potentially fraudulent activity. The transmission of the location along with the requested account modification raises account holder awareness of the whereabouts of the reset password activity and guides the account holder in decision making. Sending the location of the device originating the modification request in the SMS template to the account holder device significantly enhances security and provides protection from phishing attempts.

In some embodiments, methods 400, 500, 600, 700, and 800 may include additional steps or operations. Furthermore, the methods may include steps shown in each of the other methods. As one of ordinary skill in the art would understand, the methods of 400, 500, 600, 700, and 800 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non- removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
detecting a request to perform an account modification to an account of an account holder at an authentication portal;
identifying and recording a location associated with the request;
transmitting a short messaging service (SMS) message to the account holder identifying the account modification and the recorded location and requesting a positive confirmation from the account holder to authorize the account modification from the recorded location; and
triggering a one-time password (OTP) sent via SMS to the account holder upon receiving the positive confirmation from the account holder.

2. The method of claim 1, further comprising:
transmitting a message generation request to generate the OTP from the authentication portal to an identity authenticator, wherein the request to generate the OTP includes the recorded location or an originating IP address and a confirmation flag indicating that confirmation by the account holder is required before generating the OTP.

3. The method of claim 1, further comprising identifying, through interaction with a location service, the location based on an internet protocol (IP) address associated with the request to perform an account modification.

4. The method of claim 3, further comprising recording the IP address and the location at the identity authenticator.

5. The method of claim 1, further comprising, upon receiving a matching response OTP at the authentication portal, modifying the account in accordance with the account modification and transmitting an SMS notification to the account holder indicating that the account modification has been completed.

6. The method of claim 1, the method further comprising transmitting an SMS notification to the account holder indicating that the account modification has been prevented upon receiving a negative confirmation from the account holder.

7. The method of claim 1, the method further comprising:
upon a passing of a predetermined timeout period from the SMS message to the account holder without receiving the positive confirmation or a negative confirmation, transmitting an SMS notification to the account holder indicating that the account modification has been prevented.

8. The method of claim 1, wherein the account modification is a reset password operation or a change contact information request.

9. The method of claim 2, wherein the location or IP address is a parameter for a generateTempPin command.

10. The method of claim 2, wherein the confirmation flag is a Boolean parameter for a generateTempPin command.

11. A system comprising:
an authentication portal including at least one electronic processor configured to perform authentication operations, the authentication operations comprising:
receiving a request to perform an account modification to an account of an account holder;
identifying and recording a location associated with the request;
triggering a short messaging service (SMS) message to the account holder identifying the account modification and the recorded location and requesting a positive confirmation from the account holder to authorize the account modification requested from the recorded location; and
triggering sending of a one-time password (OTP) via SMS to the account holder upon receiving the positive confirmation from the account holder.

12. The system of claim 11, further comprising an identity authenticator including at least one electronic processor performing identity operations, the identity operations comprising:
receiving a transmitted a generation request from the authentication portal for generating the OTP, the generation request containing an Internet Protocol (IP) address or the location associated with the request to perform the account modification and a confirmation flag indicating that confirmation by the account holder is required before generating the OTP, and
generating a confirmation request message, wherein the confirmation request message notifies the account holder of the requested account modification and the location and instructs the account holder to reply with a positive confirmation response to approve the requested account modification.

13. The system of claim 12, further comprising an SMS delivery service including at least one electronic processor performing delivery operations including transmitting the confirmation request message to the account holder.

14. The system of claim 13, wherein the identity operations further comprise:
upon receiving a negative confirmation response from the account holder, transmitting an SMS notification to the account holder via the SMS delivery service indicating that the requested account modification has been prevented and upon receiving a positive confirmation response from the account holder, permitting the account modification and transmission of the OTP.

15. The system of claim 13, wherein the identity operations further comprise:
upon a passing of a predetermined timeout period from the confirmation request message being transmitted to the account holder without receiving the positive confirmation response or a negative confirmation response, transmitting an SMS notification to the account holder via the SMS delivery service indicating that the requested account modification has been prevented.

16. The system of claim 11, wherein the requested account modification is one of a reset password operation or a change contact information request.

17. The system of claim 12, wherein the authentication operations further comprise receiving the Internet Protocol (IP) address and determining the location from the IP address.

18. A method comprising:
receiving a request from a user having an IP address to perform a requested account modification on an account of an account holder at an authentication portal;
associating the IP address with a location;
transmitting an SMS confirmation request to the account holder, wherein the SMS confirmation request indicates the requested account modification and the location and asks the account holder to provide a positive confirmation response to authorize the requested account modification or a negative confirmation response to prevent the requested account modification;
receiving the positive confirmation response via SMS from the account holder;
upon receiving the positive confirmation response, generating a one-time password (OTP) and transmitting the OTP to the account holder;
receiving a response OTP at the authentication portal from the user; and
upon validating that the response OTP matches the generated OTP, performing the requested account modification and notifying the account holder via SMS that the requested account modification has been completed. 19 The method of claim 18, further comprising transmitting a request to generate the OTP to an identity authenticator, wherein the request to generate the OTP includes the location or IP address and a confirmation flag indicating that confirmation from the account holder is required to authorize the requested account modification.

20. The method of claim 19, further comprising:
upon receiving the negative confirmation response from the account holder, transmitting an SMS notification to the account holder indicating that the requested account modification has been prevented; and
upon a passing of a predetermined timeout period from the transmitting an SMS confirmation request to the account holder without receiving the positive confirmation response or a negative confirmation response, transmitting an SMS notification to the account holder indicating that the requested account modification has been prevented.
